(19) United States
(12) Patent Application Publication
(10) Pub. No.: US 2019/0171947 A1
(43) Pub. Date: Jun. 6, 2019

(54) METHODS AND APPARATUS FOR SEMANTIC KNOWLEDGE TRANSFER

(71) Applicant: Telefonaktiebolaget LM Ericsson (publ), Stockholm (SE)

(72) Inventors: Saravanan Mohan, Chennai (IN); Arindam Banerjee, Howrah (IN)

(21) Appl. No.: 16/324,214

(22) PCT Filed: Aug. 10, 2016
(86) PCT No.: PCT/IN2016/050268

§ 371 Date: Feb. 8, 2019

(51) Int. Cl. G06N 5/02; G06K 9/62; G06N 3/04; G06F 17/27

(52) U.S. Cl. CPC G06N 5/022; G06K 9/6215; G06F 17/2785; G06F 17/277; G06N 3/04

(57) ABSTRACT

A method for transferring semantic knowledge between domains of a network is disclosed, the network comprising a first domain and a second domain. The method comprises establishing a semantic knowledge base for the first domain, the semantic knowledge base comprising concepts of the first domain, properties of the first domain concepts, relationships between the first domain concepts, and constraints governing the first domain concepts. The method further comprises establishing a semantic information base for the second domain, the semantic information base comprising concepts of the second domain. The method further comprises, for a concept of the second domain, determining measures of similarity between the second domain concept and concepts of the first domain and identifying, on the basis of the determined measures of similarity, a first domain concept which is equivalent to the second domain concept.

### TECHNICAL FIELD

The present disclosure relates to methods and apparatus for transferring semantic knowledge between domains of a network. The present disclosure also relates to a computer program configured, when run on a computer, to carry out a method for transferring semantic knowledge between domains of a network.

### BACKGROUND

The “Internet of Things” refers to devices enabled for communication network connectivity, so that these devices may be remotely managed, and data collected or required by the devices may be exchanged between individual devices and between devices and application servers. The Internet of Things thus provides the information infrastructure for the “Networked Society”. As illustrated in FIG. 1, industry verticals such as energy, utilities, transport and security are at the forefront of the ongoing integration of physical and computer based systems envisaged in the Networked Society, and enabled by the Internet of Things.

Machine to Machine (M2M) communication refers to communication between connected devices that are not associated with a human user, and thus provides the basis for communication between devices in the Internet of Things. FIG. 2 illustrates a high level functional architecture for M2M, as specified in the European Telecommunications Standards Institute (ETSI) Technical Specification: “Machine to Machine communications (M2M); Functional architecture”. The M2M architecture of FIG. 2 is resources based, and may be used for the exchange of data and events between devices in a wide range of different industries. Referring to FIG. 2, elements of the Network Domain of the example M2M architecture will be highly similar for all industries integrating the Internet of Things in industrial development. However, the Device and Gateway Domain, and M2M Applications and Service Capabilities, will vary across different industries.

As integration of communication network technologies into established industry verticals continues, the boundaries between verticals are blurring through shared relationships with customers, partners and data. New business models facilitated by the Internet of Things require cross industry partnerships, and give rise to new hybrid industries such as digital medicine, precision agriculture and smart manufacturing. A significant obstacle to such integration and cooperation between industries is the lack of interoperability between systems related to the different industries. For example, when seeking to integrate software applications from different industries, it is often the case that the relevant applications use different terminologies to describe the same domain, or a particular service within the domain. Even when applications use the same terminology, they often have a different semantical association for a particular term, impeding information exchange between the applications. In order to resolve this problem, it is necessary to explicitly specify the semantics for each set of application terminology in an unambiguous fashion, for example by representing the semantics of the terminology in the form of predicate logic and assembling the representation into a Semantic Knowledge Base for the application or industry. Generating such a semantic knowledge base is a time consuming and costly process, requiring significant investment and time from human experts. Once assembled, semantic knowledge bases may be aligned to enable interoperability among different applications.

Semantic heterogeneity in different industries and applications is thus a significant challenge in the ongoing integration of industrial services. When multiple heterogeneous devices from different industrial domains act on a common problem, efficient communication between the devices is vital for information exchange and decision making. Enabling such communication requires the development and exchange of semantic knowledge bases for each device set, so that devices from different domains can interpret information and act in cooperation. Individually developing semantic knowledge bases for each device set, and training each device set with the appropriate knowledge from other device sets with which they must cooperate, are therefore ongoing challenges for the continued exploitation of opportunities afforded by the Internet of Things.

### SUMMARY

It is an aim of the present disclosure to provide a method and apparatus which obviate or reduce at least one or more of the challenges mentioned above.

According to a first aspect of the present disclosure, there is provided a method for transferring semantic knowledge between domains of a network, the network comprising a first domain and a second domain. The method comprises establishing a semantic knowledge base for the first domain, the semantic knowledge base comprising concepts of the first domain, properties of the first domain concepts, relationships between the first domain concepts, and constraints governing the first domain concepts. The method further comprises establishing a semantic information base for the second domain, the semantic information base comprising concepts of the second domain. The method further comprises, for a concept of the second domain, determining measures of similarity between the second domain concept and concepts of the first domain and identifying, on the basis of the determined measures of similarity, a first domain concept which is equivalent to the second domain concept. The method further comprises, for the concept of the second domain, mapping properties, relationships and constraints from the semantic knowledge base of the first domain which apply to the identified first domain concept to the second domain concept, and populating a semantic knowledge base for the second domain with the second domain concept and the mapped properties, relationships and constraints.

Aspects of the present disclosure thus enable the development of a semantic knowledge base for a second network domain on the basis of concepts matched between the second network domain and a first network domain, and using domain knowledge in the form of properties, relationships and constraints that are transferred from the first to the second domain in accordance with the matched concepts.

According to examples of the disclosure, the properties and relationships of the semantic knowledge bases may be expressed as predicates, and the constraints of the semantic knowledge bases may be expressed as predicate clauses.

According to examples of the disclosure, establishing the semantic knowledge base for the first domain may comprise assembling a set of documents associated with the first domain, identifying keywords from the assembled document set, and defining concepts from the identified keywords.

According to examples of the disclosure, establishing the semantic knowledge base for the first domain may further comprise extracting properties of the defined concepts and relationships between the defined concepts from the documents of the document set.

According to examples of the disclosure, establishing the semantic knowledge base for the first domain may further comprise establishing constraints governing the defined concepts in accordance with the operation of the first domain.

According to examples of the disclosure, establishing the semantic knowledge base for the first domain may comprise retrieving the semantic knowledge base from a memory. The semantic knowledge base for the first domain may for example already have been assembled by a combination of automated feature extraction and classification and human expert definition of concept predicates and constraints. The assembled semantic knowledge base for the first domain may in such examples be retrieved from the memory or storage facility in which it has been stored.

According to examples of the disclosure, establishing the semantic information base for the second domain may comprise assembling a set of documents associated with the second domain, identifying keywords from the assembled document set, and defining concepts from the identified keywords.

According to examples of the disclosure, determining measures of similarity between the second domain concept and concepts of the first domain may comprise, for each of at least a plurality of the first domain concepts, calculating a combined similarity measure between the first domain concept and the second domain concept, the combined similarity measure comprising a combination of at least one of: a relational similarity measure, a property based similarity measure, a structural similarity measure and/or an instances based similarity measure.

According to examples of the disclosure, the relational similarity measure may comprise a semantic similarity measure calculated using a lexical database. The lexical database may for example be WordNet.

According to examples of the disclosure, the property based similarity measure may comprise a measure of similarity between properties of the first domain concept and the second domain concept.

According to examples of the disclosure, the structural based similarity measure may comprise a measure of similarity between hierarchical relations of the first domain concept with other first domain concepts and hierarchical relations of the second domain concept with other second domain concepts.

According to examples of the disclosure, the instances based similarity measure may comprise a measure of occurrence of data instances of the first concept in the first domain and the second concept in the second domain.

According to examples of the disclosure, identifying, on the basis of the determined measures of similarity, a first domain concept which is equivalent to the second domain concept may comprise identifying the first domain concept having the highest value of the combined similarity measure as the equivalent concept.

According to examples of the disclosure, identifying, on the basis of the determined measures of similarity, a first domain concept which is equivalent to the second domain concept may comprise identifying the first domain concept having the highest value of the combined similarity measure as the equivalent concept if the highest value of the combined similarity measure is above a similarity threshold value.

According to examples of the disclosure, the steps of determining measures of similarity between the second domain concept and concepts of the first domain, and identifying, on the basis of the determined measures of similarity, a first domain concept which is equivalent to the second domain concept, may be performed by an Artificial Neural Network (ANN).

According to examples of the disclosure, determining measures of similarity between the second domain concept and concepts of the first domain may comprise writing first domain concepts, properties and relationships to input nodes of the ANN and writing the second domain concept to an input node of the ANN, calculating, in intermediate nodes of the ANN, measures of similarity between the first domain concepts and the second domain concept, and outputting, at each output node of the ANN, a measure of similarity between a particular first domain concept and the second domain concept. According to some examples of the disclosure, the method may further comprise writing any available properties and relationships of the second domain concept to the input node of the ANN with the second domain concept.

According to examples of the disclosure, identifying, on the basis of the determined measures of similarity, a first domain concept which is equivalent to the second domain concept may comprise identifying the output node with the highest value similarity measure, and identifying the first domain concept associated with the identified output node as the equivalent first domain concept.

According to examples of the disclosure, the semantic information base for the second domain may further comprise at least some properties of second domain concepts and/or at least some relationships between second domain concepts.

According to examples of the disclosure, determining measures of similarity between the second domain concept and concepts of the first domain may comprise determining the measures of similarity on the basis of the properties and/or relationships in the second domain semantic information base. These properties and/or relationships may be written to the input nodes of the ANN in addition to the second domain concepts and the first domain concepts, properties and relationships.

According to examples of the disclosure, the method may further comprise repeating the determining, identifying, mapping and populating steps for another second domain concept, and inputting the mapped properties, relationships and constraints populated into the second domain semantic knowledge base to the determining of measures of similarity between the other second domain concept and concepts of the first domain.

According to examples of the disclosure, the method may further comprise refining the semantic knowledge base for the second domain using expert knowledge.

According to examples of the disclosure, a relationship measure between the first domain and the second domain may be above a domain relationship threshold.

According to examples of the disclosure, the first domain and the second domain may comprise a single operational domain of the network, and the semantic knowledge base of the first domain may comprise a semantic knowledge base associated with a first application operating within the operational domain of the network, and the semantic information base of the second domain may comprise a semantic information base associated with a second application operating in the operational domain of the network.

According to examples of the disclosure, the first and second applications may be associated with first and second device sets operating within the operational domain of the network.

According to another aspect of the present disclosure, there is provided a computer program comprising instructions which, when executed on at least one processor, cause the at least one processor to carry out a method as claimed in any one of the preceding claims.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

According to another aspect of the present disclosure, there is provided apparatus for transferring semantic knowledge between domains of a network, the network comprising a first domain and a second domain. The apparatus comprises a processor and a memory, the memory containing instructions executable by the processor such that the apparatus is operative to establish a semantic knowledge base for the first domain, the semantic knowledge base comprising concepts of the first domain, properties of the first domain concepts, relationships between the first domain concepts, and constraints governing the first domain concepts. The apparatus is further operative to establish a semantic information base for the second domain, the semantic information base comprising concepts of the second domain, and for a concept of the second domain, to determine measures of similarity between the second domain concept and concepts of the first domain and identify, on the basis of the determined measures of similarity, a first domain concept which is equivalent to the second domain concept. The apparatus is further operative to, for the concept of the second domain, map properties, relationships and constraints from the semantic knowledge base of the first domain which apply to the identified first domain concept to the second domain concept, and populate a semantic knowledge base for the second domain with the second domain concept and the mapped properties, relationships and constraints.

According to examples of the disclosure, the apparatus may be further operative to carry out a method according to any one of the preceding aspects and examples of the present disclosure.

According to another aspect of the present disclosure, there is provided apparatus for transferring semantic knowledge between domains of a network, the network comprising a first domain and a second domain. The apparatus is adapted to establish a semantic knowledge base for the first domain, the semantic knowledge base comprising concepts of the first domain, properties of the first domain concepts, relationships between the first domain concepts, and constraints governing the first domain concepts. The apparatus is further adapted to establish a semantic information base for the second domain, the semantic information base comprising concepts of the second domain, and for a concept of the second domain, to determine measures of similarity between the second domain concept and concepts of the first domain and identify, on the basis of the determined measures of similarity, a first domain concept which is equivalent to the second domain concept. The apparatus is further adapted to, for the concept of the second domain, map properties, relationships and constraints from the semantic knowledge base of the first domain which apply to the identified first domain concept to the second domain concept, and populate a semantic knowledge base for the second domain with the second domain concept and the mapped properties, relationships and constraints.

According to another aspect of the present disclosure, there is provided apparatus for transferring semantic knowledge between domains of a network, the network comprising a first domain and a second domain. The apparatus comprises a knowledge module configured to establish a semantic knowledge base for the first domain, the semantic knowledge base comprising concepts of the first domain, properties of the first domain concepts, relationships between the first domain concepts, and constraints governing the first domain concepts. The apparatus further comprises an information module configured to establish a semantic information base for the second domain, the semantic information base comprising concepts of the second domain. The apparatus further comprises a transfer module configured to, for a concept of the second domain, determine measures of similarity between the second domain concept and concepts of the first domain, identify, on the basis of the determined measures of similarity, a first domain concept which is equivalent to the second domain concept, map properties, relationships and constraints from the semantic knowledge base of the first domain which apply to the identified first domain concept to the second domain concept, and populate a semantic knowledge base for the second domain with the second domain concept and the mapped properties, relationships and constraints.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a representation of the Networked Society;

FIG. 2 is a high level functional architecture for Machine to Machine Communication;

FIG. 3 is a flow chart illustrating process steps in a method for transferring semantic knowledge between domains of a network;

FIG. 4 is a flow chart illustrating process steps in another example of a method for transferring semantic knowledge between domains of a network;

FIG. 5 is a flow chart illustrating process sub-steps in example methods for establishing a semantic knowledge base for a domain;

FIG. 6 is a flow chart illustrating process sub-steps in an example method for establishing a semantic information base for a domain;

FIG. 7 is a flow chart illustrating process sub-steps which may be conducted as part of the methods of FIGS. 3 and 4;

FIG. 8 is a representation of an Artificial Neural Network;

FIG. 9 is a flow chart illustrating process steps in a search and retrieval method conducted in a telecoms domain;

FIG. 10 is a flow chart illustrating process steps in a method for establishing a semantic knowledge base for a telecoms domain;

FIG. 11 illustrates a concepts space for a telecoms domain;

FIG. 12 illustrates a concepts space for another telecoms domain;

FIG. 13 is a block diagram illustrating functional units in an apparatus;

FIG. 14 is a block diagram illustrating functional units in another example of apparatus; and

FIG. 15 is a flow chart illustrating steps which may be conducted in an implementation of the methods of FIGS. 3 and 4.

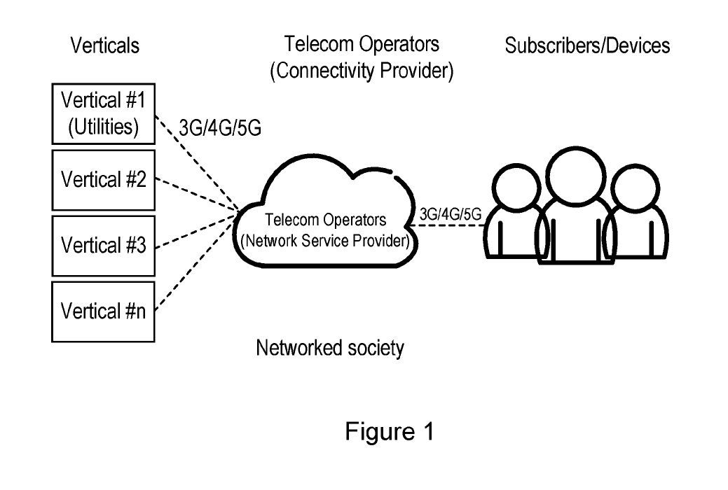

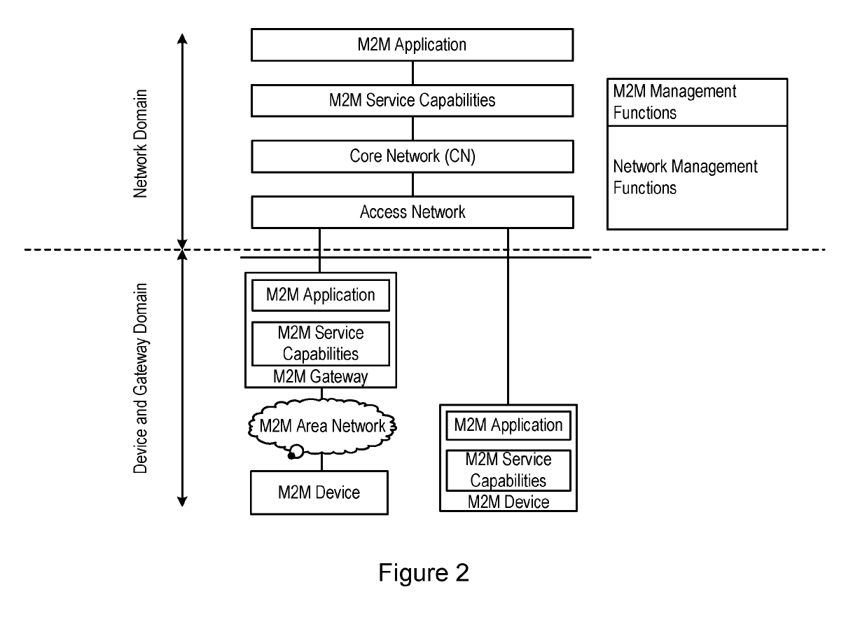

### DETAILED DESCRIPTION

Aspects of the present disclosure thus provide a method according to which semantic knowledge may be transferred across network domains from a first, or source, domain to a second, or target domain. This transferred knowledge is assembled into a semantic knowledge base for the second or target domain, which may then be refined and expanded by a human expert. Aspects of the present disclosure thus avoid the need for a semantic knowledge base to be developed from scratch by human experts.

Examples of the present disclosure may automatically achieve interoperability among vertical domains or services in industry and society by enabling understanding of different semantics associated with different network domains, and/or applications or device sets operating in the network domains, through transfer learning. A new transfer learning algorithm and neural networking approach are also provided in the present disclosure.

According to examples of the present disclosure, the first or source domain and second or target domain may share a relationship which may be manifest in common entities across the domains and/or similarities in the functionality of the domains. In addition, the semantics of the common entities may be specified by standard predicate logic, and all considered sub-domains may adhere to standards and communicate using the same entities in an unambiguous fashion. A transformation mapping may be used to establish connections between entities in different domains, and a semantic heterogeneity may be identified between the domains on the basis of domain knowledge and defined semantics. An automatic reasoning may then be performed without human assistance to resolve conflicts and thus transfer knowledge from the source domain to the target domain.

The semantic knowledge transfer enabled by aspects of the present disclosure may be applied in a wide range of use cases including, but not limited to, Internet of Things. As discussed above, providing interoperability among heterogeneous device sets and applications is an important building block in facilitating the automation, tracing, information representation, storage and knowledge exchange that will enable cross domain partnerships and the development of new hybrid domains. Semantic modelling of devices can be used to represent domain knowledge, and that knowledge can be reused, extended and interlinked in order to develop cross-domain applications through knowledge transfer according to aspects of the present disclosure. In an Internet of Things environment, the sensors, actuators, RFID tags etc. used in different domains (smart home, healthcare, transport system, agriculture etc.) can be leveraged to represent domain specific knowledge in the form of semantic graphs. This knowledge can be transferred to a new domain using examples of the present disclosure in order to develop a backbone knowledge base for this new domain. Domain experts may then enhance the knowledge base by fine-tuning the semantic annotations for concepts and properties.

In addition to transferring domain knowledge to new or related domains, knowledge transfer according to examples of the present disclosure may also be used in situations where different heterogeneous applications or device sets are deployed within the same operational domain. An operational domain may correspond for example to an industry vertical such as energy, water, healthcare, transport, telecoms etc., or to any other division or sub-division of industrial operating space. When heterogeneous devices are employed in a single operational domain, the domain specific knowledge acquired from one sector, for example SMART POWER GRID in an energy operational domain, may be transferred to another sector in the operational domain, for example SMART GAS. This may enable devices to which the knowledge is transferred to become operational more quickly; a key advantage for rapidly growing Internet of Things domains, where interconnection among devices from multiple vendors and software from third parties is required.

Another use case in which the semantic knowledge transfer enabled by aspects of the present disclosure may be applied is telecommunications, in which equivalent functions may be performed by a range of different products offered and maintained by different vendors. Telecoms customer service is one area in which domain interoperability could provide significant advantages. Customer Service Responses (CSR) contain complaints made by customers regarding malfunctioning or errors generated by a specific product, as well as the solutions provided by the customer support team who address the complaint. When a customer service request arrives, the customer support team analyses the request, identifies the problem or error and proposes a solution within a specific period of time. The correctness of the solution depends upon the experience and expertise of the person handling the complaint. Availability of a suitable expert with domain knowledge cannot be ensured all of the time, meaning that delays may be experienced by customers regarding certain products. The correctness of the solution may also depend upon the number and scope of previous complaints relating to the same product, and availability of a previous solution to a similar problem may significantly reduce the time required for proposing a solution to a new problem.

The above challenges could be addressed if knowledge from previous complaints could be leveraged not only for a single product but also for different but related products. For example, the Charging Control Node (CCN) and Online Charging Control (OCC) are two charging products, each representing a specific domain with its own terminology and semantics. However, each product fulfils a very similar need, and thus there is considerable similarity between both the entities within the domain space and the relationships between them. Facilitating interoperability between the CCN and OCC domains would greatly increase the base of previous complaints available to assist in the resolution of new complaints, as well as enabling domain experts to operate across domains.

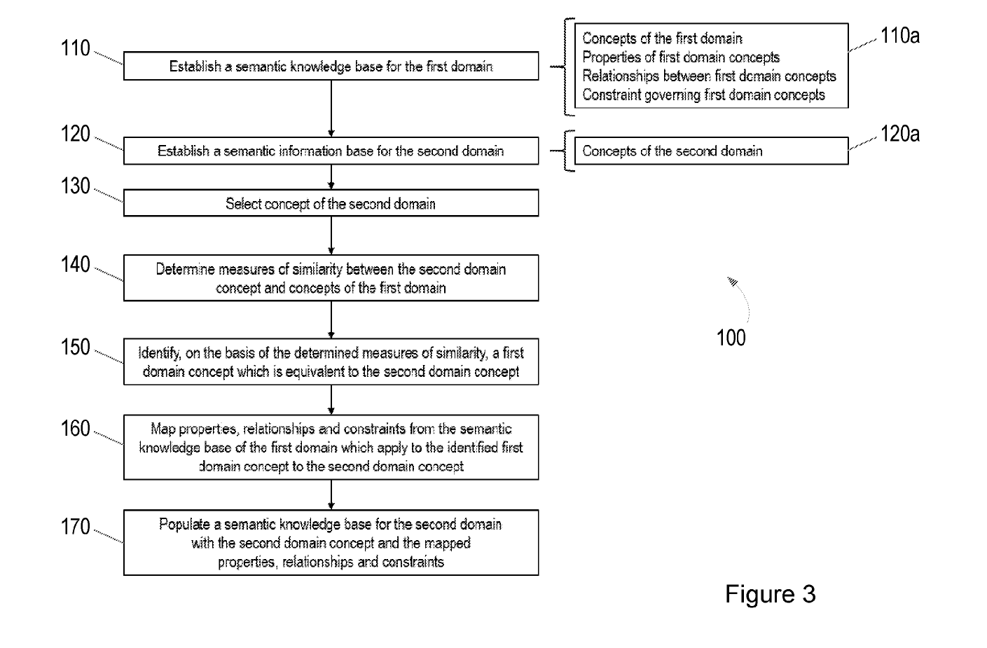

FIG. 3 is a flow chart illustrating process steps in a method 100 for transferring semantic knowledge between domains of a network according to an aspect of the present disclosure. The network comprises at least a first or source domain and a second or target domain. Referring to FIG. 3, the method 100 comprises a first step 110 of establishing a semantic knowledge base for the first domain. As illustrated at 110a, the semantic knowledge base comprises concepts of the first domain, properties of the first domain concepts, relationships, which may be hierarchical relationships, between the first domain concepts, and constraints governing the first domain concepts. In some examples, as discussed in further detail below, the properties of the concepts and relationships between the concepts may be expressed as predicates, and the constrains governing the concepts may be expressed as predicate clauses. In step 120, the method 100 comprises establishing a semantic information base for the second domain, the semantic information base comprising concepts of the second domain as illustrated at 120a. The semantic information base may also comprise some basic properties and relationships of the second domain concepts, such as may be extracted from basic metadata associated with the first domain concepts. The method 100 then comprises selecting a concept of the second domain in step 130 and determining measures of similarity between the second domain concept and concepts of the first domain in step 140. The method 100 then comprises, in step 150, identifying, on the basis of the determined measures of similarity, a first domain concept which is equivalent to the second domain concept and mapping, in step 160, properties, relationships and constraints from the semantic knowledge base of the first domain which apply to the identified first domain concept to the second domain concept. The method 100 then comprises, in step 170, populating a semantic knowledge base for the second domain with the second domain concept and the mapped properties, relationships and constraints.

In some examples of the present disclosure, the first and second domains may be related, and a relationship measure between the first domain and the second domain may be above a domain relationship threshold.

In further examples, the first domain and the second domain may comprise a single operational domain of the network. The semantic knowledge base of the first domain may comprise a semantic knowledge base associated with a first application or device set operating within the operational domain of the network, and the semantic information base of the second domain may comprise a semantic information base associated with a second application or device set operating in the operational domain of the network. Knowledge transfer may thus take place between applications or device sets which operate in the same domain but use different semantics to describe the domain.

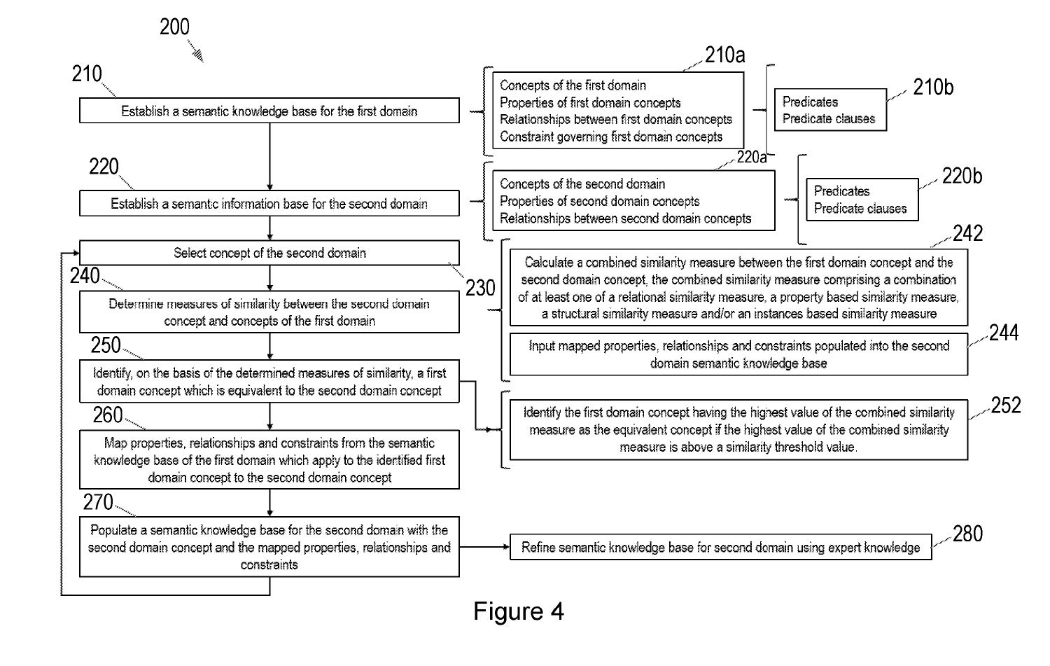

FIGS. 4 to 7 are flow charts illustrating process steps in another method 200 for transferring semantic knowledge between domains of a network according to an aspect of the present disclosure. The steps of the method 200 demonstrate one example way in which the steps of the method 100 may be implemented and supplemented to achieve the above discussed and additional functionality.

Referring to FIG. 4, in a first step 210, the method 200 comprises establishing a semantic knowledge base for the first or source domain. A domain D may consist of four components: Concepts space Ψ, Predicates set P, Constraints C and Variables V. So, D=<Ψ, P, C, V>. The variables of a domain are instances, used as quantifiers for the concepts of a domain. Predicates represent both domain concept properties and relationships between concepts. Properties of domain concepts may include product specific, domain specific or technical properties of a particular concept. Relationships between concepts may be hierarchical and indicate how different concepts are linked or interrelated, including for example parent-child or sibling relationships. As illustrated at 210a, the semantic knowledge base comprises concepts of the first domain, properties of the first domain concepts, relationships between the first domain concepts, and constraints governing the first domain concepts. As illustrated in 210b, the properties of the concepts and relationships between the concepts may be expressed as predicates, and the constrains governing the concepts may be expressed as predicate clauses. Examples of concepts, predicates and predicate clauses for a telecoms use case are given below:

Concepts: ccn, problem, module, service
Predicate: TypeOf(module, problem), TypeOf(service, problem)
Constraint: {memory⊂module⊂problem}

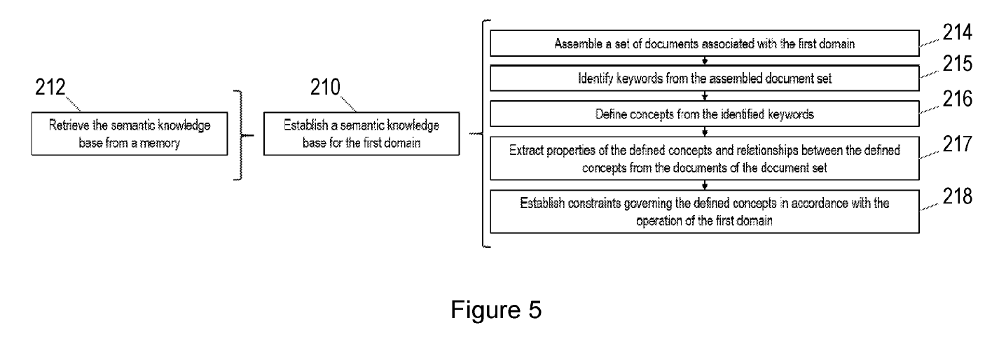

FIG. 5 illustrates additional sub-steps which may be performed in order to establish the semantic knowledge base for the first domain in step 210. Referring to FIG. 5, in one example, illustrated at step 212, the semantic knowledge base for the first domain may already be in existence. It may therefore be sufficient to retrieve the concepts, properties and relationships (expressed as predicates), and constraints (expressed as predicate clauses), from a suitable memory where the semantic knowledge base is stored. In another example, illustrated at steps 214 to 218, the semantic knowledge base may be developed involving a greater or lesser degree of human expert intervention. In a first sub-step 214, a set of documents is assembled, which documents are associated with the first domain. At sub-step 215, keywords are identified from the assembled document set, and concepts are then defined from the assembled keywords in sub-step 216. In sub-step 217, properties of the defined concepts and relationships between the defined concepts are extracted from the document set, and may be expressed in predicate form. Finally, in sub-step 218, constraints governing the defined concepts are established in accordance with the operation of the first domain.

Referring again to FIG. 4, having established the semantic knowledge base for the first domain, the method 200 then comprises, at step 220, establishing a semantic information base for the second domain, the semantic information base comprising concepts of the second domain. As illustrated at 220a, the semantic information base of the second domain may also comprise some properties of second domain concepts and relationships between second domain concepts, which may be expressed as predicates as illustrated at 220b. For example, single stage relationships between second domain concepts, and basic second domain concept properties may be developed from basic metadata of the second domain concepts.

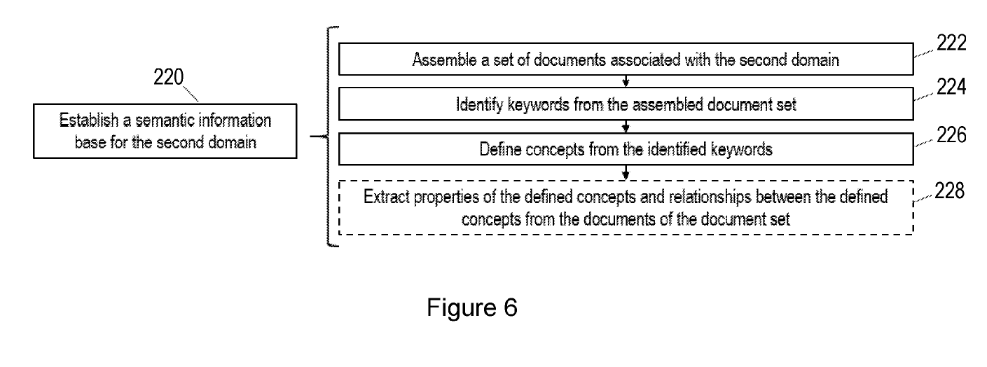

FIG. 6 illustrates additional sub-steps which may be performed in order to establish the semantic information base for the second domain in step 220. Referring to FIG. 6, in one example, establishing a semantic information base for the second domain may comprise, at sub-step 222, assembling a set of documents associated with the second domain. Keywords are then identified from the assembled document set in sub-step 224, and concepts are defined from the identified keywords in sub-step 226. In sub-step 228, properties of the identified concepts and relationships between the identified concepts may be extracted from the documents and expressed in predicate form. As mentioned above, basic properties and single stage relationships for the second domain concepts may be developed from basic metadata extracted for the second domain concepts.

Referring again to FIG. 4, once the first domain semantic knowledge base and second domain semantic information base are established, the method 200 then comprises selecting a concept of the second domain in step 230, determining measures of similarity between the second domain concept and concepts of the first domain in step 240, and, in step 250, identifying, on the basis of the determined measures of similarity, a first domain concept which is equivalent to the second domain concept. As illustrated at step 242, determining measures of similarity between the second domain concept and concepts of the first domain may comprise calculating a combined similarity measure between the second domain concept and concepts of the first domain, the combined similarity measure comprising a combination of at least one of a relational similarity measure, a property based similarity measure, a structural similarity measure and/or an instances based similarity measure. As illustrated in step 244, properties, relationships and constraints which have already been mapped from the first domain to the second domain and populated into the second domain semantic knowledge base may be input to the calculation of similarity measures. In this manner, the accuracy of the mapping between concepts of the first and second domains may be continually improved, as predicates describing second domain concepts become available as the method continues. As illustrated in step 252, identifying a first domain concept which is equivalent to the second domain concept may comprise identifying the first domain concept having the highest value of the combined similarity measure as the equivalent concept, if the highest value of the combined similarity measure is above a similarity threshold value.

The method 200 then comprises mapping, in step 260, properties, relationships and constraints from the semantic knowledge base of the first domain which apply to the identified first domain concept to the second domain concept. In step 270, a semantic knowledge base for the second domain is populated with the second domain concept and the mapped properties, relationships and constraints. The method may then return to step 230 and select another second domain concept for calculation of similarity measures and knowledge transfer, until all second domain concepts have been considered. Finally, the populated semantic knowledge base of the second domain may be refined in step 280 using intervention from human domain experts.

According to examples of the present disclosure, steps 240 to 270 may be performed using a Concept Matching Algorithm as defined below.

### Concept Matching Algorithm:

Input: Concept Set Ψ = {C₁, C_{2,} . . . Cₘ ∈ R^{|m|}} from first domain, Predicates set P = {P₁,
P₂, . . . Pₙ ∈ R^{|n|}} from first domain, each identified concept and any corresponding
predicates from second domain.
Output: Matching score of the selected second domain concept with the set of first domain
concepts
1: procedure Concept_Matching(Ψ, P)
2: clauseConstraint Set := { }
3: similarityIndex := 0
3: FOR each Concept c extracted from Corpus of (Destination Domain)
4: count similarityIndex between source and destination concepts based upon
relational similarity from domain WordNet, property based similarity, structural similarity
and instances based similarity
5: IF similarityIndex > = Threshold θ THEN
6: transfer domain knowledge from the Source Concept to Destination Concept
7: update clause Constraint Set with the newly acquired knowledge of destination
concept
8: END IF
9: similartIndex := 0
10: END FOR
11: return Concept Similarity Set
12: END procedure

The probability of a concept c to be matched with some concept from Ψ may be expressed as:

arg maxₖP(c|Ψ), if maxₖP(c|Ψ)>θ

Where, Ψ=input set of concepts to be matched,
θ=rejection threshold
Concept-Predicate co-occurrence in two knowledge bases (W₁, W₂) may be expressed as:

$$β ( C , P ) = {\sum }_{x = 1}^{m} {\sum }_{y = 1}^{n} ℱ ( {C}_{x}^{′} = {C}_{y} ) \cdot ℱ ( {P}_{x}^{′} = {P}_{y} ) , \\ ∀ ( C , P ) ∈ {W}_{1} \times {W}_{2}$$

### Where:

### P=Predicates,

### C=Concepts,

β=Concept Predicate co-occurrence function,
x and y iterate over the two knowledge bases W₁ and W₂.

In the above described Concept Matching Algorithm, an Edge-based similarity calculation may be used to compute the relational similarity measure, which may express semantic similarity between two concepts as the semantic similarity between the two words of the concepts using a lexical database such as WordNet. An edge based similarity calculation measures the distance of paths linking the words and the position of the words in the database.

Wu and Palmer (Wu, Z., Palmer, M.: Verb semantics and lexical selection. In: 32nd. Annual Meeting of the Association for Computational Linguistics, pp. 133-138. New Mexico State University, Las Cruces, N. Mex. (1994)) propose measuring the conceptual similarity of two concepts by calculating their closeness in a hierarchy using a path between them:

$$sim ( C 1 , C 2 ) = \frac{2 * {N}_{3}}{{N}_{1} + {N}_{2} + 2 * {N}_{3}}$$

If C3 is the least common super-concept of C1 and C2, N1 is the number of nodes on the path from C1 to C3, N2 is the number of nodes on the path from C2 to C3 and N3 is the number of nodes on the path from C3 to root.

A property based similarity measure may be used to compare the properties of two concepts to find their similarity index. If the index is more than a predefined threshold then it would be considered as a close relationship and thus eligible to transfer knowledge. Two concepts are compatible if they have the same types of arguments with the available clause constraints. According to Resnik (Philip Resnik: Using information content to evaluate semantic similarity in a taxonomy. In In Proceedings of the 14th International Joint Conference on Artificial Intelligence, pages 448-453, 1995.), similarity between two concepts C1 and C2 can be measured by:

sim(C1,C2)=max_{c∈S(C1,C2)}(−log(p(c))

Where (−log(p(c)) presents the information content of a concept c quantified as negative the log likelihood.

A structural similarity measure may be used to compare hierarchical relationships between concepts while ignoring actual data content. A structural similarity measure may be based upon shared information between compared concepts, a hierarchical structure of the knowledge bases within which the concepts appear, placement of super-class concepts and sub-class concepts within the knowledge base etc.

An instances based similarity measure may be used to compare annotated data instances of concepts while ignoring any structural likeness. The higher the percentage of co-occurring instances for two concepts from different knowledge bases, the greater the similarity between the knowledge bases.

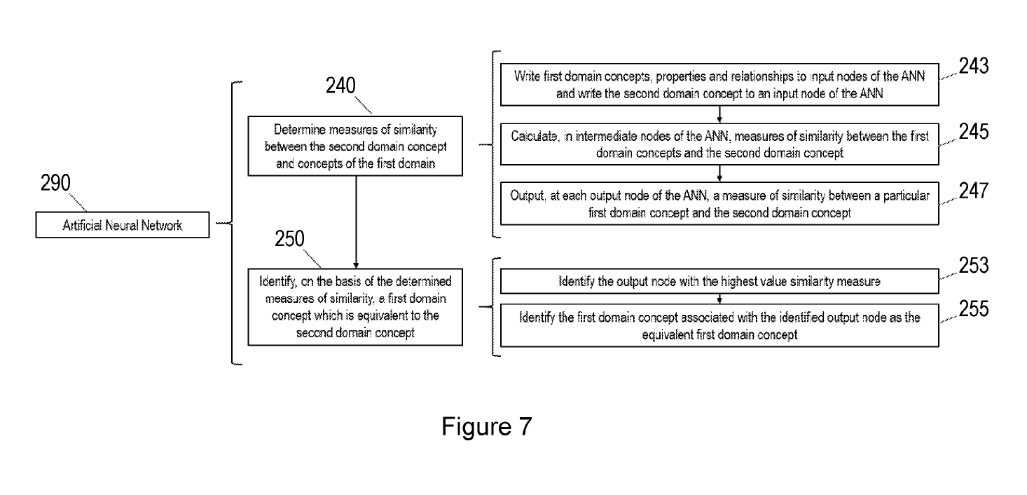

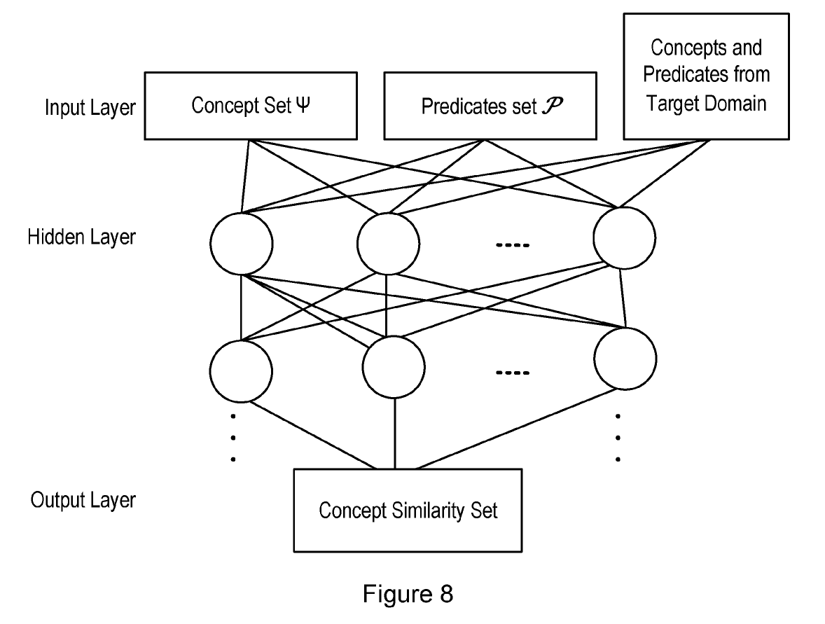

In some examples of the present disclosure, at least the steps of determining similarity measures and identifying equivalent concepts may be performed by an Artificial Neural Network (ANN), as illustrated in FIG. 7, step 290 and FIG. 8. Referring to FIGS. 7 and 8, in a first sub-step 243, first domain concepts and properties and relationships (expressed as predicates) are written to input nodes of the ANN. Each concept from the second domain is also written one by one to an input node of the ANN together with any available predicates. As discussed above, single stage relationships between some second domain concepts and basic properties of some second domain concepts may have been developed from basic metadata extracted from the source documents for the second domain concepts. Such relationships and properties for each second domain concept may be written to the input node of the ANN together with the relevant second domain concept. In sub-step 245, hidden intermediate nodes of the ANN calculate measures of similarity between the first domain concepts and the second domain concept. At sub-step 247, a measure of similarity between a particular first domain concept and the second domain concept under consideration is written to each output node. In sub-step 253, the output node having the highest value similarity measure is identified, and in sub-step 255, the first domain concept associated with the identified output node is identified as the equivalent first domain concept to the second domain concept under consideration. This identification may be made dependent upon the similarity measure of the identified node being above a similarity threshold value.

Once the equivalent first domain concept has been identified, domain knowledge in the form of predicates and constraints may be mapped from the first domain semantic knowledge base and transferred to their matched counterparts in the second domain semantic knowledge base. The predicates may include properties and relationships of the matched first domain concept, including for example multiple relationships with various other first domain concepts. The logical alignment of the transferred constraints may be verified in the second domain. As properties and relationships are transferred to the semantic knowledge base for the second domain, these properties and relationships become available for inclusion at the input node of the ANN when concept matching. As the process is repeated for the remaining second domain concepts, a backbone semantic knowledge base for the second domain is established in an automated fashion from the transferred properties, relationships and constraints, so avoiding the investment of human effort and time required to develop a semantic knowledge base from scratch. Human intervention may provide additional input in fine-tuning and refining the semantic knowledge base for the second domain, once it has been populated using the ANN. Referring to the example of a telecom charging solution, from a fully functional CCN node, a backbone semantic knowledge base of related product OCC may be established by transferring domain knowledge from CCN to OCC. A fully connected, feed-forward, neural network has inputs as Concept Set Ψ from domain CCN, Predicates set P from domain CCN and each concept and corresponding predicates from OCC Domain. The k^{th} neuron gives output yₖ as:

$${y}_{k} = ϕ ( {\sum }_{j = 0}^{m} {w}_{{k}_{j}} {x}_{j} )$$

### Where:

Φ=output function,
x=input value
w=weight assigned.

The output of the kth neuron is thus the weighted sum of the inputs to that neuron. The (k−1)th hidden unit produces y(k−1) and residual error:

ε₍ₖ₋₁₎=y₍ₖ₋₁₎−yₖ

The objective function to be optimised is:

$$\frac{∅ ( {ɛ}_{( k - 1 )} , {x}_{j} )}{{\vert {x}_{j} \vert}^{2}}$$

where ø is a square function of product of two vectors, with a bias unit x₀ and actual inputs x₁ to xₘ.

An activation function may be chosen as a log sigmoid function:

h_{θ}(t)∈R^{|φ|},ψ=Concept Set

to get the output in the range of 0 and 1.

$${h}_{θ} ( t ) = \frac{1}{1 + {e}^{- {θ}^{Y} t}}$$

Here, θ=matrix of weights controlling function mapping from one layer to the next layer. The cross domain WordNet contains the relationship among cross domain concepts. Equivalent concepts are closely placed in a graphical structure.

Initially the set of constraint clauses for OCC remains an empty set. Each concept from the OCC domain is then fetched to compare with all existing concepts of the source domain CCN. The similarity measures between the OCC concept and all CCN concepts are calculated individually based upon relational similarity (for example in WordNet), property based similarity, structural similarity and instances based similarity. If the concept having highest similarity index from CCN becomes greater than a predefined similarity threshold value, then it is considered to be a suitable match for the OCC concept under consideration. Domain knowledge in the form of predicates and predicate clauses is then transferred from the CCN concept to the OCC concept. This process continues until all the concepts from OCC are mapped with some CCN concept.

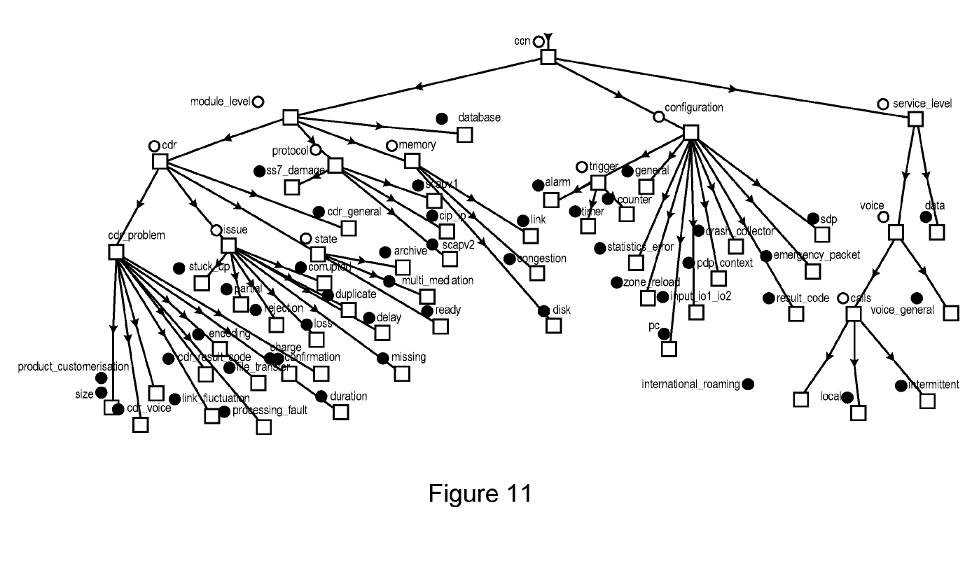

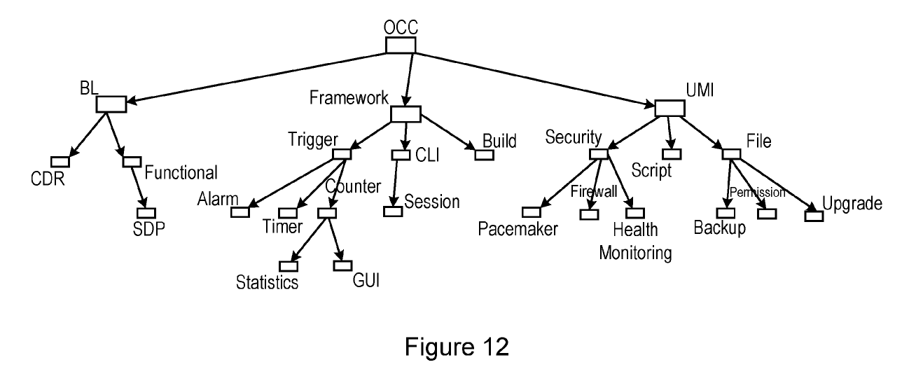

The concept matching and knowledge transfer process are illustrated briefly below referring to example concepts from the CNN and OCC domains, as illustrated in FIGS. 11 and 12.

“CCN” and “OCC” are root concepts for the two domains. The WordNet similarities and predicates (such as: IsRootConcept(C₁)) of these two concepts are properly matched and knowledge may be transferred. If “framework” from OCC and “configuration” from CCN are then considered, their WordNet, properties and predicate based similarities (such as: IsASubClassOf(C₁, C₂) where C1 may be “framework” and “configuration” and C2 may be “OCC” and “CCN”) would be properly matched. Hence knowledge in the form of predicates and predicate clauses may be transferred from “configuration” to “framework” one by one. For example, a constraint clause for OCC may be updated as ‘framework’⊂̅“OCC”. This constraint may then be taken into account when concept matching the next OCC concept. The concept “counter” is present in both the domains, and when checking the property and structural similarity it may be established that the concepts “counter” in the two domains are closely matched, as in CCN, “counter” is a sub-concept of “configuration” and in OCC, “counter” is a sub-category of “framework”, “configuration” and “framework” being themselves closely matched concepts. Domain knowledge in the form of predicates and constraint predicate clauses may therefore be transferred between the “counter” concepts of the two domains.

Predicates and constraint predicate clauses for the above discussed concepts are summarised in the table below:

Predicates:
IsRootConcept (CCN), IsRootConcept (OCC)
IsASubClassOf (configuration, CCN), IsASubClassOf (framework,
OCC)
IsASubClassOf (counter, configuration), IsASubClassOf (counter,
framework)
.
.
.
Constraint Clauses:
framework ⊆ OCC
counter ⊆ framework ⊆ OCC

As discussed above, concepts and predicates from both domains, to the extent that they are available, may be used as inputs to the ANN. The most similar concepts are matched and constraints and predicates are transferred allowing the inputs to the system to be updated with the transferred knowledge from the source domain. Eventually, a semantic knowledge base for the target domain is developed. The target domain may correspond for example to a new device set, for which sufficient labelled data is not available. The knowledge base of a different device set may then be used as the source domain for knowledge transfer. Often, a small set of labelled data and large amount of unlabelled data will be available. The neural network may be trained with the labelled data, and the continual updating with predicates and constraints from matched concepts may ensure a gradual improvement in matching accuracy.

An example implementation of the above described methods and processes is illustrated below, with reference to the above mentioned telecoms use case.

The heterogeneous nature of the products and services related to charging and billing systems for telecommunication domains mean that log data collected for these products is highly complicated. However, the similarity between the functions performed by different products means that problems concerning different products may have very similar features. Domain knowledge may therefore be transferred between charging and billing products using examples of the methods described above.

Text mining techniques may be used to classify problems reported by customers for a particular product automatically, enabling the building of a semantic knowledge base for the product. Domain knowledge for this product may then be transferred using the methods of the present disclosure in order to develop knowledge bases for similar products. With an established knowledge base, which has either been generated by experts or transferred in accordance with aspects of the present disclosure, incoming problems may be classified and solutions searched for. Classification of problems involves extracting the unique features of a particular Customer Service Response (CSR) and determining classifier labels for the CSR through combinations of these features. Classification enables efficient search and retrieval of problems and their associated solutions. By transferring a knowledge base from a target to a source domain, classification and search for solution of problems may take place in the target domain without the need for extensive expert input to generate the knowledge base. Classification may be performed on the basis of the transferred knowledge base, which may then be refined and expanded by experts on the basis of incoming CSRs.

According to the present implementation example, a system for responding to customer reported problems may be developed with prior domain knowledge, enabling customer service teams to search efficiently for solutions within the existing base of resolved problems. In addition, the particular customer organisation in which the problem occurred can be traced, and any history of similar problems related to that customer can be listed, enabling customer service teams to determine the component or device at fault.

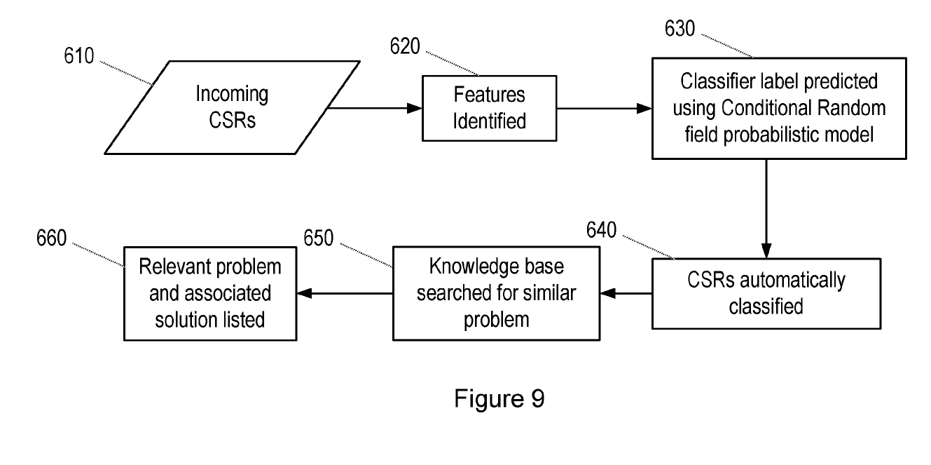

FIG. 9 illustrates search and retrieval of related problems on the basis of incoming CSRs. Referring to FIG. 9, incoming CSRs 610 are received and features of the incoming CRSs are identified in step 620. On the basis of the retrieved features, a classifier label for the CSRs is predicted using a Conditional Random field probabilistic model in step 630. In step 640, the CSRs are automatically classified and in step 650, the knowledge base is searched for similar problems. In step 660, relevant problems and associated solutions for the knowledge base are presented.

An algorithm for the search and retrieval process is illustrated below:

```
Process 1: Prepare a bag of Words
Start
  - Pre-process the entire data set.
      Corpus C=R^{D}
      where C is the collection of documents D:= {d₁, d₂, . . . , dₘ}
      |C|: Volume of collection i.e. total number of documents
      Vocabulary V = R^{W}
      W:= {w₁, w₂, . . . , w_{N}) where V is the vocabulary of stop words
  - Remove the stop words.
  C \ (V ∩ C)
  - Determine the frequency count of the words.
  f(tf, idf_{t,d}_{ᵢ}) = tf_{t,d}_{ᵢ} * idfₜ
    IDF normalization, penalize frequent terms: =
$log \frac{1 + \vert C \vert}{\{ document frequency df \text{?} \vert ∃ {d}_{i} \text{?} {d}_{i} \text{?} D \vert t \text{?} {d}_{i} \}}$
    Document length normalization, penalize longer documents:
      $Pivoted Normalizer N = 1 - b + b \frac{\vert d \vert}{avg , \vert {d}_{i} \vert}$
      b ∈ [0, 1]
  - Take the frequently occurring words as keywords.
  - Based on domain knowledge prepare the list of keywords
belonging to different category.
      Bag of words B = R^{P} | P := set of unique keywords
Stop
$\text{?} \text{indicates text missing or illegible when filed}$
```

Process 2: Classification:

```
Start
    Identify keywords using GATE tool.
    Perform Feature Extraction.
    For (each keyword in the file)
  {
      Determine the category to which it belongs
  }
    Get the frequency count of the keywords under each classifier label.
    Classify the file into the classifier label which has the maximum
    count.
Stop
```

Process 3: Retrieval of similar cases based on keyword match

```
Start
  Initialize keyword_match to zero
  Set the threshold (minimum number of keyword matches essential) for
  each category (classifier label)
  Determine the classification to which the incoming file belongs by
  calling CLASSIFICATION Process
  For that particular classification
  {
    For each keyword in the incoming file
    {
      Compare the keywords with the keywords of the classified file.
      If keyword matches
      Increment keyword_match
    }
    if (keyword_match>threshold) //evaluating the best match
      Retrieve the best matched file containing the problem.
    }
Stop
```

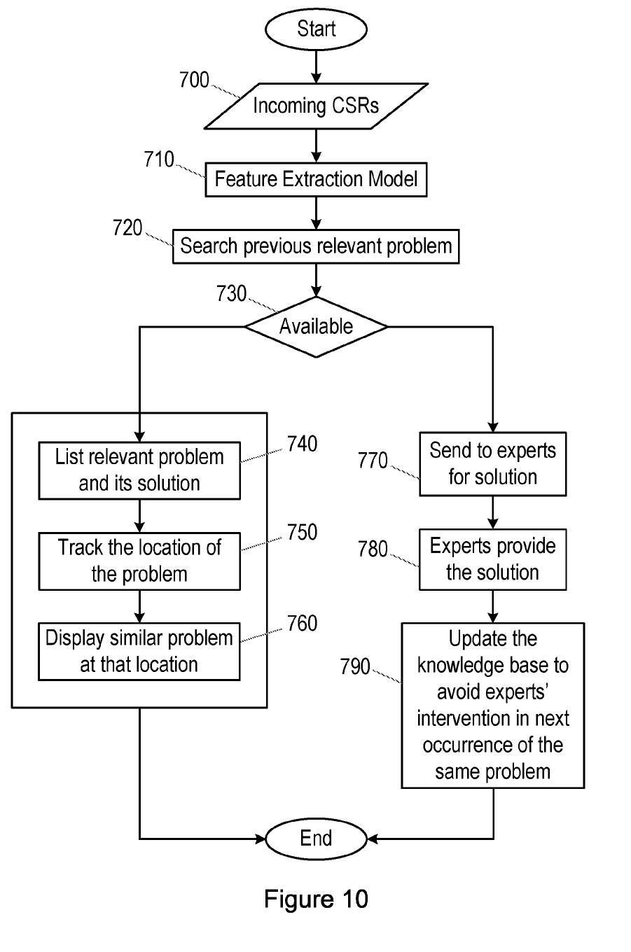

FIG. 10 illustrates in greater detail how the problem retrieval may operate in cases where earlier relevant problems may or may not be available. Referring to FIG. 10, incoming CSRs 700 are received and in step 710, a feature extraction model permits the identification of features and in some examples, the classification of the incoming CSRs. In step 720, the process searches for earlier relevant problems for a particular incoming CSR. If earlier relevant problems are available (left branch of step 730), the relevant earlier problems are listed with their solutions in step 740. The location of the problem of the particular incoming CSR is tracked in step 750 and similar problems from the list that occurred at the tracked location are displayed in step 760. Returning to step 730, if earlier relevant problems are not available (right branch of step 730), the particular incoming CSR is sent to experts for a solution in step 770. An expert solution is provided at step 780 and the knowledge base is updated at step 790 to include the new problem and solution, and so avoid the need for expert input in future occurrences of the same problem. By updating the knowledge base with new expert solutions, domain knowledge may be regularly updated, so either contributing to the development of a useful source semantic knowledge base or refining a target semantic knowledge base which has been transferred in accordance with aspects of the present disclosure.

Referring to the example charging products CCN and OCC discussed above, with a fully functional semantic knowledge base for product CCN, an initial semantic knowledge base for related product OCC may be established by transferring domain knowledge from CNN to OCC in accordance with aspects of the present disclosure. The CCN semantic knowledge base is developed by gathering concepts, preparing functional predicates describing properties of the concepts and relationships between the concepts, and preparing constraints in the form of predicate clauses. Domain specific OCC concepts are then extracted from the OCC corpus to prepare the OCC semantic information base, and basic corresponding predicates are formalised, allowing for concept matching and knowledge transfer.

The results of a test implementation of knowledge transfer in accordance with aspects of the present disclosure are now presented.

The test dataset comprised 900 CNN Customer Service Responses (CSRs) in the form of mailing lists. 700 CSRs were reserved for training and 200 CSRs were reserved for testing. A corpus of documents was assembled for the OCC domain to enable checking of knowledge transfer. Using the training dataset, a model to automatically classify incoming files was built and trained. Using the testing dataset, the model trained was tested for correctness and accuracy. Domain knowledge was then transferred to the OCC domain.

In a first phase of the test implementation, CNN CSRs underwent Text Preprocessing, Feature Extraction and Classification, and a knowledge base was constructed. Text preprocessing involved Tokenization, Stop Word Removal and Determining Term Frequency in order to produce the Bag of Words to be used as keyword features in the next phase of the test implementation. Features were then extracted and used for uniquely identifying each document and classifying it into an appropriate category. Finally the semantic knowledge base for the CNN domain was developed manually from the extracted keywords and classified documents. CCN knowledge representation is illustrated in FIG. 11.

Key phrases were then extracted from the OCC CSRs. Owing to the similarity between the OCC and CCN products, it was possible to transfer domain knowledge from CCN to OCC to generate an OCC semantic knowledge base in a process as described above with reference to FIGS. 4 to 7. Transferred predicate clauses were verified in the target OCC domain to ensure they satisfied domain properties. By transferring knowledge from the source CCN domain, a semantic knowledge base of approximately 40%-60% of the target final size was developed automatically in the target OCC domain. The semantic knowledge base was then fine-tuned using manual intervention. OCC knowledge representation is illustrated in FIG. 12, and some examples of concept matching between CCN and OCC are given in the table below:

| CCN | OCC |
|---|---|
| Module | BL |
| Configuration | Framework |
| Service | UMI |
| Protocol | Functional |

Once the semantic knowledge base for OCC was developed, OCC CSRs were classified using the transferred knowledge base and the results are shown in the table below. “Precision” is the fraction of retrieved CSRs that are relevant to the find query. “Recall” is the fraction of the CSRs relevant to the query that are successfully retrieved. The F-measure, or balanced F-score=(2*P*R)/(P+R), is the harmonic mean of precision and recall.

| CLASSIFIER | | | |
|---|---|---|---|
| LABEL | PRECISION | RECALL | F-MEASURE |
| CONGESTION | 1.00 | 1.00 | 1.00 |
| LINK | 1.00 | 1.00 | 1.00 |
| DISK | 0.97 | 0.97 | 0.97 |

The above discussed example implementation illustrates application of methods according to the present disclosure in the telecoms domain. When considering application to an Internet of Things use case, core domain knowledge may consist of physical entities, units, data types, properties, predicates, formulas etc. This domain knowledge may be reused, interlinked and extended using the techniques of the present disclosure to build cross-domain applications, as domain knowledge for any particular domain, for example healthcare, may be reused in other domains including for example tourism, transport etc. In a first example application, if two heterogeneous device sets are employed in the same domain, then the knowledge base acquired by one device set may be at least partially transferred to the other device set. In a second example application, if a new domain or sub-domain evolves, its knowledge base need not be developed from scratch. Semantic knowledge from similar domains may be transferred enabling the automatic generation of at least a part of the knowledge base for the new domain or sub-domain. Domain experts may then fine-tune the new knowledge base requiring greatly reduced time and effort comparted to generating the entire new semantic knowledge base. In a third example, it may be appropriate to merge multiple domain knowledge bases to develop a new domain. A healthcare service for example may require development of a knowledge base from multiple domains including anatomy, general patient data, disease data etc., with data having been collected by a range of devices including smart medical devices. In such cases, the domains to be merged share certain similarities and/or are substantially aligned or related to each other. If the semantic knowledge bases for the source domains are available then their domain knowledge can be transferred to the destination domain and the knowledge base of the destination domain can be at least partially developed automatically using the techniques of the present disclosure.

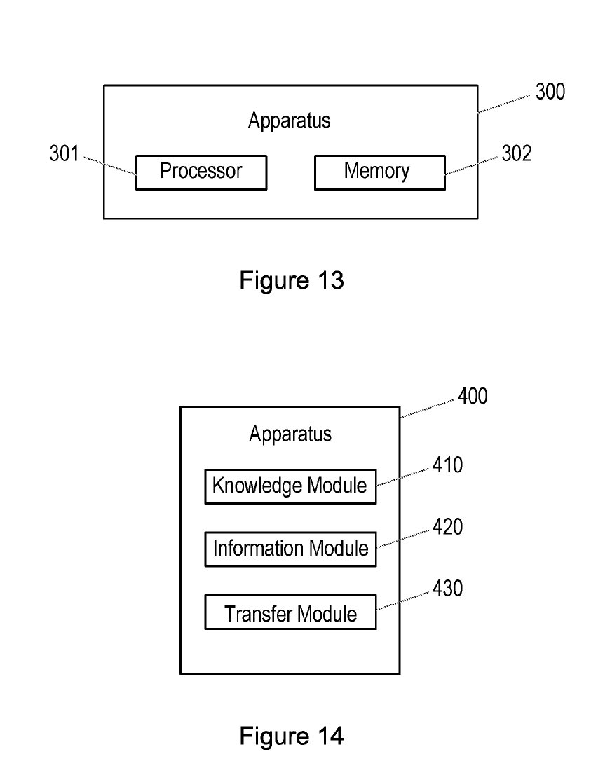

The methods of the present disclosure may be conducted in an apparatus. FIG. 13 illustrates an example apparatus 300 which may implement the methods 100, 200 for example on receipt of suitable instructions from a computer program. Referring to FIG. 13, the apparatus 300 comprises a processor 301 and a memory 302. The memory 302 contains instructions executable by the processor 301 such that the apparatus 300 is operative to conduct some or all of the steps of the methods 100 and/or 200.

FIG. 14 illustrates an alternative example apparatus 400, which may implement the methods 100, 200, for example on receipt of suitable instructions from a computer program. It will be appreciated that the units illustrated in FIG. 14 may be realised in any appropriate combination of hardware and/or software. For example, the units may comprise one or more processors and one or more memories containing instructions executable by the one or more processors. The units may be integrated to any degree.

Referring to FIG. 14, the apparatus 400 comprises a knowledge module 410 configured to establish a semantic knowledge base for the first domain, the semantic knowledge base comprising concepts of the first domain, properties of the first domain concepts, relationships between the first domain concepts, and constraints governing the first domain concepts. The apparatus further comprises an information module 420 configured to establish a semantic information base for the second domain, the semantic information base comprising concepts of the second domain. The apparatus further comprises a transfer module 430 configured to, for a concept of the second domain, determine measures of similarity between the second domain concept and concepts of the first domain, identify, on the basis of the determined measures of similarity, a first domain concept which is equivalent to the second domain concept, map properties, relationships and constraints from the semantic knowledge base of the first domain which apply to the identified first domain concept to the second domain concept, and populate a semantic knowledge base for the second domain with the second domain concept and the mapped properties, relationships and constraints.

The knowledge module 410 may be configured to establish the semantic knowledge base for the first domain by assembling a set of documents associated with the first domain, identifying keywords from the assembled document set, and defining concepts from the identified keywords.

The knowledge module 410 may be further be configured to establish the semantic knowledge base for the first domain by extracting properties of the defined concepts and relationships between the defined concepts from the documents of the document set.

The knowledge module 410 may be further be configured to establish the semantic knowledge base for the first domain by establishing constraints governing the defined concepts in accordance with the operation of the first domain.

The knowledge module 410 may be further be configured to establish the semantic knowledge base for the first domain by retrieving the semantic knowledge base from a memory.

The information module 420 may be configured to establish the semantic information base for the second domain by assembling a set of documents associated with the second domain, identifying keywords from the assembled document set, and defining concepts from the identified keywords.

The transfer module 430 may be configured to determine measures of similarity between the second domain concept and concepts of the first domain by, for each of at least a plurality of the first domain concepts, calculating a combined similarity measure between the first domain concept and the second domain concept, the combined similarity measure comprising a combination of at least one of: a relational similarity measure, a property based similarity measure, a structural similarity measure and/or an instances based similarity measure.

The transfer module 430 may be configured to identify, on the basis of the determined measures of similarity, a first domain concept which is equivalent to the second domain concept by identifying the first domain concept having the highest value of the combined similarity measure as the equivalent concept.

The transfer module 430 may be configured to identify, on the basis of the determined measures of similarity, a first domain concept which is equivalent to the second domain concept by identifying the first domain concept having the highest value of the combined similarity measure as the equivalent concept if the highest value of the combined similarity measure is above a similarity threshold value.

The transfer module 430 may be configured to conduct the steps of determining measures of similarity between the second domain concept and concepts of the first domain, and identifying, on the basis of the determined measures of similarity, a first domain concept which is equivalent to the second domain concept, by referring these steps to an Artificial Neural Network (ANN).

The transfer module 430 may be configured to determine measures of similarity between the second domain concept and concepts of the first domain by writing first domain concepts, properties and relationships to input nodes of the ANN and writing the second domain concept to an input node of the ANN, causing the ANN to calculate, in intermediate nodes of the ANN, measures of similarity between the first domain concepts and the second domain concept, and causing the ANN to output, at each output node of the ANN, a measure of similarity between a particular first domain concept and the second domain concept.

The transfer module 430 may be configured to identify, on the basis of the determined measures of similarity, a first domain concept which is equivalent to the second domain concept by identifying the output node with the highest value similarity measure, and identifying the first domain concept associated with the identified output node as the equivalent first domain concept.

The apparatus 400 may be configured to repeat the determining, identifying, mapping and populating steps for another second domain concept, and to input the mapped properties, relationships and constraints populated into the second domain semantic knowledge base to the determining of measures of similarity between the other second domain concept and concepts of the first domain.

Aspects of the present disclosure thus provide methods and apparatus enabling the transfer of semantic knowledge between domains of a network. Domain concepts, their properties and relationships in predicate form, and constraints of a source domain are already known. Aspects of the present disclosure leverage knowledge acquired in the source domain to enhance the accuracy and speed of learning in a related target domain. Predicates and constraints are mapped from the source to the target domain, and predicates are then aligned in the target domain in accordance with the constraints, and so the knowledge base of the target domain is developed. Methods and apparatus according to the present disclosure thus reduce the time and training data required to learn a model of a target domain when compared with the process of learning a target domain knowledge base from scratch.

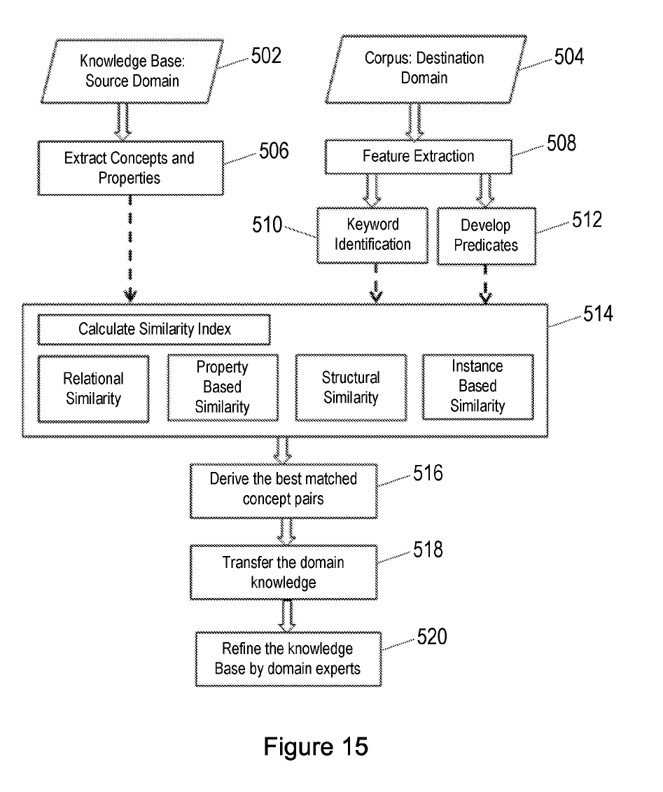

FIG. 15 presents an overview of examples of methods of the present disclosure, with inputs comprising a source domain knowledge base 502 and a corpus of source documents for a destination domain 504. From the source domain knowledge base, concepts and predicates are extracted at 506. From the destination domain corpus, features are extracted at 508, keywords are identified at 510 and predicates developed at 512. A similarity index or combined similarity measure is then calculated at 514, the combined similarity measure based on a combination of relational similarity, property based similarity, structural similarity and instance based similarity. At 516, the most closely matched concept pairs are identified and at 518 the domain knowledge, in the form of predicates and constraints, is transferred from the source to the target domain. Finally, at 520, the destination knowledge base is refined by domain experts.

While systems for linking and mapping knowledge across domains are known, examples of the present disclosure enable the creation of an entirely new knowledge base for a domain, for which the domain information is available but the semantic knowledge is not present. Acquired knowledge from a related existing domain is leveraged to enable creation of the new knowledge base requiring greatly reduced investment in time, cost and human effort compared to manually creating the new knowledge base form scratch.

Examples of the present disclosure may be particularly applicable to use in telecoms domains, in which multiple similar products are often available from different suppliers, and in Internet of Things domains. In the Internet of Things, as discussed above, interoperability between device sets and applications is a key building block to achieving cross domain applications and services. Aspects of the present disclosure can facilitate such interoperability by enabling the fast automated development of semantic knowledge bases of target domains.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for transferring semantic knowledge between domains of a network, the network comprising a first domain and a second domain, the method comprising:
establishing a semantic knowledge base for the first domain, the semantic knowledge base comprising:
concepts of the first domain;
properties of the first domain concepts;
relationships between the first domain concepts; and
constraints governing the first domain concepts;
establishing a semantic information base for the second domain, the semantic information base comprising:
concepts of the second domain;
and, for a concept of the second domain:
determining measures of similarity between the second domain concept and concepts of the first domain;
identifying, on the basis of the determined measures of similarity, a first domain concept which is equivalent to the second domain concept;
mapping properties, relationships and constraints from the semantic knowledge base of the first domain which apply to the identified first domain concept to the second domain concept; and
populating a semantic knowledge base for the second domain with the second domain concept and the mapped properties, relationships and constraints.

2. The method as claimed in claim 1, wherein the properties and relationships of the semantic knowledge bases are expressed as predicates, and wherein the constraints of the semantic knowledge bases are expressed as predicate clauses.

3. The method as claimed in claim 1, wherein establishing the semantic knowledge base for the first domain comprises:
assembling a set of documents associated with the first domain;
identifying keywords from the assembled document set; and
defining concepts from the identified keywords.

4. The method as claimed in claim 3, wherein establishing the semantic knowledge base for the first domain further comprises:
extracting properties of the defined concepts and relationships between the defined concepts from the documents of the document set.

5. The method as claimed in claim 3, wherein establishing the semantic knowledge base for the first domain further comprises:
establishing constraints governing the defined concepts in accordance with the operation of the first domain.

6. The method as claimed in claim 1, wherein establishing the semantic knowledge base for the first domain comprises retrieving the semantic knowledge base from a memory.

7. The method as claimed in claim 1, wherein establishing the semantic information base for the second domain comprises:
assembling a set of documents associated with the second domain;
identifying keywords from the assembled document set; and
defining concepts from the identified keywords.

8. The method as claimed in claim 1, wherein determining measures of similarity between the second domain concept and concepts of the first domain comprises, for each of at least a plurality of the first domain concepts:
calculating a combined similarity measure between the first domain concept and the second domain concept, the combined similarity measure comprising a combination of at least one of:
a relational similarity measure
a property based similarity measure
a structural similarity measure and/or
an instances based similarity measure.

9. The method as claimed in claim 8, wherein the relational similarity measure comprises a semantic similarity measure calculated using a lexical database.

10. The method as claimed in claim 8, wherein the property based similarity measure comprises a measure of similarity between properties of the first domain concept and the second domain concept.

11. The method as claimed in claim 8, wherein the structural similarity measure comprises a measure of similarity between hierarchical relations of the first domain concept with other first domain concepts and hierarchical relations of the second domain concept with other second domain concepts.

12. The method as claimed in claim 8, wherein the instance based similarity measure comprises a measure of occurrence of data instances of the first concept in the first domain and the second concept in the second domain.

13. The method as claimed in claim 8, wherein identifying, on the basis of the determined measures of similarity, a first domain concept which is equivalent to the second domain concept comprises identifying the first domain concept having the highest value of the combined similarity measure as the equivalent concept.

14. The method as claimed in claim 13, wherein identifying, on the basis of the determined measures of similarity, a first domain concept which is equivalent to the second domain concept comprises identifying the first domain concept having the highest value of the combined similarity measure as the equivalent concept if the highest value of the combined similarity measure is above a similarity threshold value.

15. The method as claimed in claim 1, wherein the steps of determining measures of similarity between the second domain concept and concepts of the first domain, and identifying, on the basis of the determined measures of similarity, a first domain concept which is equivalent to the second domain concept, are performed by an Artificial Neural Network, ANN.

16. The method as claimed in claim 15, wherein determining measures of similarity between the second domain concept and concepts of the first domain comprises:
writing first domain concepts, properties and relationships to input nodes of the ANN and writing the second domain concept to an input node of the ANN;
calculating, in intermediate nodes of the ANN, measures of similarity between the first domain concepts and the second domain concept; and
outputting, at each output node of the ANN, a measure of similarity between a particular first domain concept and the second domain concept.

17. The method as claimed in claim 16, wherein identifying, on the basis of the determined measures of similarity, a first domain concept which is equivalent to the second domain concept comprises;
identifying the output node with the highest value similarity measure; and
identifying the first domain concept associated with the identified output node as the equivalent first domain concept.

18-22. (canceled)

23. The method as claimed in claim 1, wherein the first domain and the second domain comprise a single operational domain of the network, and wherein the semantic knowledge base of the first domain comprises a semantic knowledge base associated with a first application operating within the operational domain of the network, and wherein the semantic information base of the second domain comprises a semantic information base associated with a second application operating in the operational domain of the network.

24. (canceled)

25. A computer program comprising instructions which, when executed on at least one processor, cause the at least one processor to:
establish a semantic knowledge base for the first domain, the semantic knowledge base comprising:
concepts of the first domain;
properties of the first domain concepts;
relationships between the first domain concepts; and
constraints governing the first domain concepts;
establish a semantic information base for the second domain, the semantic information base comprising:
concepts of the second domain;
and, for a concept of the second domain:
determining measures of similarity between the second domain concept and concepts of the first domain;
identifying, on the basis of the determined measures of similarity, a first domain concept which is equivalent to the second domain concept;
mapping properties, relationships and constraints from the semantic knowledge base of the first domain which apply to the identified first domain concept to the second domain concept; and
populating a semantic knowledge base for the second domain with the second domain concept and the mapped properties, relationships and constraints.

26. (canceled)

27. (canceled)

28. An apparatus for transferring semantic knowledge between domains of a network, the network comprising a first domain and a second domain, the apparatus comprising a processor and a memory, the memory containing instructions executable by the processor such that the apparatus is operative to:
establish a semantic knowledge base for the first domain, the semantic knowledge base comprising:
concepts of the first domain;
properties of the first domain concepts;
relationships between the first domain concepts; and
constraints governing the first domain concepts;
establish a semantic information base for the second domain, the semantic information base comprising:
concepts of the second domain;
and, for a concept of the second domain:
determine measures of similarity between the second domain concept and concepts of the first domain;
identify, on the basis of the determined measures of similarity, a first domain concept which is equivalent to the second domain concept;
map properties, relationships and constraints from the semantic knowledge base of the first domain which apply to the identified first domain concept to the second domain concept; and
populate a semantic knowledge base for the second domain with the second domain concept and the mapped properties, relationships and constraints.

29-31. (canceled)
